(19) United States
(12) Patent Application Publication
(10) Pub. No.: US 2022/0194242 A1
(43) Pub. Date: Jun. 23, 2022

(54) Charging device for charging a battery of a motor vehicle

(71) Applicant: Webasto SE, Stockdorf (DE)

(72) Inventor: Thomas Podolski, Stockdorf (DE)

(21) Appl. No.: 17/615,264

(22) PCT Filed: Jun. 8, 2020
(86) PCT No.: PCT/EP2020/065859

§ 371 Date: Nov. 30, 2021

(30) Foreign Application Priority Data
Jun. 7, 2019 (DE) 10 2019 115 601.7

(51) Int. Cl. B60L 53/35; B60L 53/18; H02J 7/00

(52) U.S. Cl. CPC B60L 53/35; H02J 7/0042; B60L 53/18

(57) ABSTRACT

The present invention relates to a charging device for charging a battery of a motor vehicle, comprising a ground unit for arrangement on the ground of a motor vehicle parking space, wherein the ground unit has a contacting arm, at the free end of which is arranged a contacting device (6) for contacting a contacting unit in the motor vehicle, the contacting unit being complementary to the contacting device, wherein the contacting arm has a main link which can pivot about a vertical pivot axis.

### CROSS-REFERENCE TO RELATED APPLICATIONS

This application is a 35 U.S.C. § 371 National Stage Entry of International Application No. PCT/EP2020/065859 filed Jun. 8, 2020, which claims the priority benefit of German Patent Application Serial Number DE 10 2019 115 601.7 filed Jun. 7, 2019, all of which are incorporated herein by reference in their entirety for all purposes.

### TECHNICAL FIELD

The present invention relates to a charging device for charging a battery of a motor vehicle, in particular for charging a traction battery of a motor vehicle driven by an electric motor, in particular for automatically charging this traction battery.

### BACKGROUND

In order to charge traction batteries in motor vehicles, it is known to establish contact between the motor vehicle and a charging device, for example a wallbox, by a charging cable being led by a user from the wallbox to the motor vehicle in order to be plugged there into a corresponding socket. In this way, a secure connection between the wallbox and the motor vehicle can be established such that charging is possible in a simple fashion.

However, providing such a wallbox combined with a cable is not a space-saving solution as the wallbox occupies a wall region, for example in a garage, and the charging cable, which extends from the wallbox to the motor vehicle, can constitute a trip hazard. Furthermore, users find the manual process of plugging the charging cable into the motor vehicle to be inconvenient. This can cause them to forget to connect the motor vehicle to charge it or even to forget that the motor vehicle is still joined to the wallbox by the charging cable when they drive off. Although locking means that stop drivers from driving off usually prevent any mechanical damage, the user nevertheless still has to get out of the motor vehicle again and detach the charging cable from the vehicle.

If users forget to charge the vehicle, this can mean that the traction battery of the motor vehicle is not charged and that the traction battery may not have enough charge when next started up.

Accordingly, efforts have been made to automate the contacting for the purpose of charging the motor vehicle using a charging device. There are various approaches to doing this, wherein, for example, wall-mounted automatic contacting devices have been proposed in which a charging cable that was previously inserted manually into the socket on the motor vehicle by a user is now plugged in automatically/mechanically. This can be achieved, for example, via a scissor arm.

Contacting devices are furthermore known which are arranged on the ground of a parking space. In the case of these contacting devices, a motor vehicle drives over the respective charging device and contact is established with the motor vehicle automatically from below via a corresponding lifting device. Various lifting devices are known for this purpose, by means of which a plug can be inserted from below into a socket which is arranged in the underbody of the motor vehicle.

For example, a charging device is known from WO 2019/060939A1 in which a contacting element is passed from below into a complementary contacting part in the underbody of a motor vehicle and contact can thus automatically be established in order to charge the motor vehicle.

The mentioned prior art offers a technology in which the actual contact takes place vertically. In the mentioned prior art, spindle drives are used to do this which are provided for the purpose of raising an arm. As a result, it correspondingly takes a long time to adjust the respective positions and at the same time the structural size of the proposed charging device is not particularly compact.

### DESCRIPTION OF THE INVENTION

The object of the present invention is accordingly to provide a charging device which enables automatic contacting of a motor vehicle but at the same time also has a compact structure and a reliable design.

The object is achieved by a charging device having the features of claim 1. Advantageous developments arise from the dependent claims, the description, and the drawings.

Accordingly, a charging device for charging a battery of a motor vehicle is proposed, comprising a ground unit for arrangement on the ground of a motor vehicle parking space, wherein the ground unit has a contacting arm, at the free end of which is arranged a contacting device for contacting a contacting unit in the motor vehicle, the contacting unit being complementary to the contacting device. According to the invention, the contacting arm has a main link which can pivot about a vertical pivot axis.

By virtue of the use of the main link which can pivot about a vertical pivot axis, a movement of the contacting arm in a horizontal plane can be obtained such that, by means of the contacting arm provided in this fashion, contacting of the contacting device with a contacting unit of a motor vehicle with a movement which extends in a plane parallel to the ground. In other words, contact can be obtained between the contacting device and the contacting unit of the motor vehicle by a movement parallel to the ground of the parking space and not, as known from the prior art, by inserting a contacting device vertically.

At the same time, a particularly low-maintenance and reliable structure of the contacting arm can be obtained by the use of a vertical pivot axis and the correspondingly provided pivoting movement of the main link. Owing to the use of the pivot joint, the contacting arm is less prone to dirt, wear, and corrosion than would be the case, for example, for a spindle drive or another linear drive.

Furthermore, owing to the use of a pivoting movement about a vertical axis, a particularly low structural height of the proposed charging device results because a housing of only a small structural size is required by virtue of the pivoting movement in the horizontal plane.

The main link is preferably attached to the ground unit such that it can pivot about the vertical pivot axis. A particularly compact structure can thus be obtained because the pivoting movement of the contacting arm is performed about the vertical pivot axis starting from the ground unit and the ground unit can hence have a particularly compact design.

The contacting arm preferably has a lifting link which can pivot about a horizontal axis, wherein the lifting link is preferably attached to the contacting device at its free end. By means of the lifting link configured in this way, in particular with the attachment to the contacting device, it is possible to ensure that the contacting device is raised to a predetermined raised height which corresponds to a contacting height at which the contacting device can be connected to a contacting element of the motor vehicle. In this design, the lifting link accordingly represents as it were the final element that carries out precise positioning of the contacting device. At the same time, when the main link is designed as the final element, it is advantageous if the main link, which can pivot about the vertical pivot axis, can accordingly be positioned within the X-Y plane and the main link then carries out the Z positioning.

The contacting arm preferably has a secondary link which can pivot about a vertical pivot axis, wherein the secondary link is preferably attached at a free end of the main link via the vertical pivot axis and/or wherein the secondary link is preferably attached to a lifting link via a horizontal pivot axis. In this way, precise positioning of the contacting device can be carried out by means of the secondary link because fine positioning within the X-Y plane can then be carried out by means of the secondary link in addition to the pivoting movement of the main link. If the secondary link is attached both to the main link and to the lifting link, it is therefore integrated precisely between the main link and the lifting link such that in this way more precise positioning can be carried out and in particular precise positioning of the lifting link in the X-Y plane can also be carried out, wherein the main link then carries out the Z positioning.

A drive is preferably provided which is configured to pivot the main link about its vertical pivot axis and/or a drive is preferably provided which is configured to pivot the secondary link about its vertical pivot axis and/or a drive is preferably provided which is configured to pivot the lifting link about its horizontal pivot axis. Automatic displacement of the contacting arm can accordingly be carried out by the provision of the said drives. The pivoting movement can thus be carried out separately and individually in a controlled fashion in each of the provided pivot joints, i.e. in particular pivoting of the main link about its vertical pivot axis, pivoting of the secondary link about its vertical pivot axis, and pivoting of the lifting link about its horizontal pivot axis.

The contacting arm is preferably accommodated completely in a housing in a rest position, wherein the components of the contacting arm, preferably a main link, a secondary link, and a lifting link, are arranged in the rest position in a plane parallel to the ground of the motor vehicle parking space. By virtue of providing a corresponding housing in which the contacting arm is accommodated completely in a rest position, it can be ensured that, when the charging device is not being used, it is protected from damage and dirt and can be arranged on the ground of the motor vehicle parking space without presenting a safety hazard to people.

In the rest position, the main link is preferably accommodated in the housing parallel to the lifting link. A particularly compact arrangement of the contacting arm in the rest position can be obtained as a result, also entailing a particularly compact structural size of the housing.

An opening, through which the contacting arm can be pivoted from the rest position into a contacting position about the vertical pivot axis of the main link is preferably provided in the housing, wherein the opening can be closed by a closure element in the rest position, wherein the closure element is preferably guided rigidly on the secondary link. By virtue of providing the opening in combination with the closure element, a completely enclosed housing can be provided in the rest position which correspondingly reduces the risk of dirt and damage for the charging device and the risk of injury to people. Because the closure element is attached rigidly to the secondary link, opening and closing of the opening of the housing can be obtained by the normal pivoting movement of the secondary link without any additional actuation means being required for this purpose.

An electronic system is preferably provided which is configured to provide a charging current to the contacting device, preferably via a power cable which is laid in the contacting arm. As a result, the charging current required to charge the traction battery can be prepared, monitored, and supplied directly in the charging device. A particularly compact design of the charging device also results hereby.

An electronic system is preferably provided which is configured to form a communication with a motor vehicle to be charged and/or which is configured to automatically control the contacting arm. The charging process can be largely automated by this electronic system.

It is in particular possible that, after the motor vehicle has parked above the charging device, it communicates with the device, determines the charging requirement for the traction battery, then automatically instructs the charging device to perform the contacting via the contacting arm, then performs the charging process, and detaches the contacting arm from the motor vehicle again after the charging process is complete.

By means of the communication between the motor vehicle and the electronic system of the charging device, it is furthermore also possible to detach the contacting arm from the motor vehicle in situations in which a user enters the motor vehicle in order to drive off in it. In a preferred embodiment, interaction of the user with the charging device is accordingly no longer necessary and instead the user can just park the motor vehicle above the charging device and does not need to concern themselves with anything else.

A support element is preferably arranged on the contacting arm and/or on the ground unit, in particular on the closure part. As a result, the contacting arm can be supported on the ground in a controlled and movable fashion such that uncontrolled grinding of the contacting arm on the ground can be prevented.

The support element preferably has at least one roller. This enables low-noise operation of the contacting arm because the contacting arm is assisted in its pivoting movement in such a way that the contacting arm does not directly touch the ground and instead comes into contact with the ground via the support element provided in the form of a roller. It is consequently possible to prevent the contacting arm grinding against the ground when the contacting arm is pivoted out. The roller is preferably a pivotable or rotatable roller which can accordingly follow the trajectory in which the contacting arm travels relative to the ground.

The support element is preferably arranged on the main link and/or on the secondary link and/or on the lifting link. A plurality of support elements can be arranged, for example, along the main link and/or the secondary link and/or the lifting link in order to ensure optimal support of the contacting arm.

The support element is particularly preferably arranged at the free end of the main link and/or at the free end of the contacting arm. As a result, the contacting arm is supported simply during operation with as few support elements as possible.

### BRIEF DESCRIPTION OF THE DRAWINGS

Preferred further embodiments of the invention are explained in detail by the following description of the drawings, in which:

FIG. 1 shows schematically a plan view of a charging device with a ground unit in which a lid has been removed to improve the view, wherein the charging device is situated in a rest position,

FIG. 2 shows the charging device from FIG. 1 in a plan view, wherein an arm, at the free end of which a contacting device is provided for contacting a contacting element in an underbody of a motor vehicle, is pivoted into an active position,

FIG. 3 shows the charging device from FIGS. 1 and 2 in a schematic perspective view, wherein the lid has here too been removed to improve the view and the charging device is situated in a rest position.

FIG. 4 shows a schematic perspective view of the charging device from FIG. 3, wherein the arm carrying the contacting element is pivoted into an active position,

FIG. 5 shows a plan view of the charging device of the preceding drawings with the arm extended in an active position, wherein the ground unit is then shown provided with a lid,

FIG. 6 shows a schematic perspective view of the charging device of the preceding drawings from a different perspective,

FIG. 7 shows a schematic side view of the charging device from FIGS. 5 and 6 in which the arm is pivoted and raised in order to establish contact with a complementary contacting unit in a motor vehicle (not shown here),

FIG. 8 shows a schematic perspective view of the charging device in a completely closed rest position, FIG. 9 shows a schematic perspective view of the charging device, wherein the arm is presently pivoted out of the rest position into an active contacting position,

FIG. 10 shows a schematic perspective view of the charging device of the preceding drawings with the arm pivoted into an active position,

FIG. 11 shows a schematic perspective view of the charging device with a support element according to a further embodiment,

FIG. 12 shows a schematic perspective view of the charging device with a support element from FIG. 11 with the arm extended in an active position, and

FIG. 13 shows a schematic side view of the charging device with a support element from FIGS. 11 and 12 in which the arm is pivoted and raised in order to establish contact with a complementary contacting unit in a motor vehicle (not shown here).

### DETAILED DESCRIPTION OF PREFERRED EXEMPLARY EMBODIMENTS

Preferred exemplary embodiments are described below with the aid of the drawings. Elements which are identical, similar, or have the same effect are here provided with identical reference signs in the various drawings and a repeated description of these elements can be omitted in order to avoid redundancy.

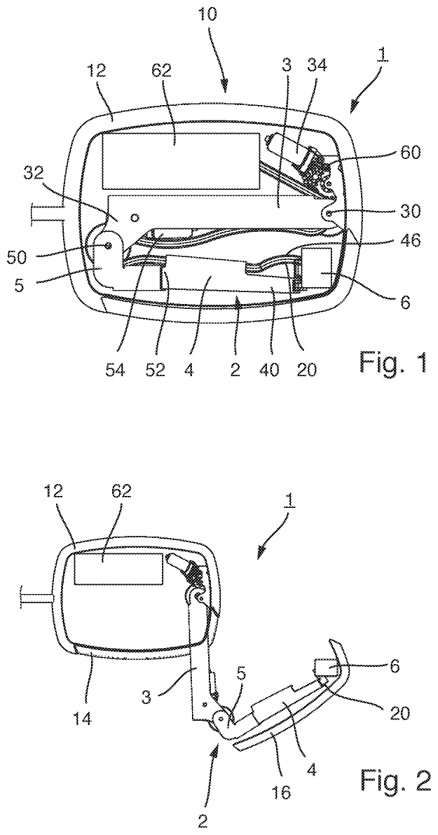

A charging device 1 is shown in FIG. 1 in a schematic plan view which has a ground unit 1 which can be arranged on the ground of a parking space which is provided for a motor vehicle which is to be charged.

The charging device 1 serves to establish contact automatically with a motor vehicle and then to initiate a charging process in order to charge a traction battery in the motor vehicle. The intention here is to ensure by means of the charging device 1 that the whole contacting process and the charging process proceed essentially automatically such that the driver or the user of the motor vehicle does not need to intervene. The driver just needs to position or park the vehicle above the ground unit 10 and the remaining steps of the contacting process and charging process then take place without any further interaction with the driver or user. In other words, automatic communication between the motor vehicle to be charged and the charging device 1 can take place and automatically initiate a charging process if, for example, the charging level is below a predetermined charging state of the motor vehicle. It can, however, also be provided that the driver actively initiates the charging process but then at least no further manual interaction between the driver and the charging device 1 is necessary.

The charging device 1 will then establish physical contact with the motor vehicle via a contacting mechanism described below in order in this way to supply a charging current in order to charge the traction battery of the motor vehicle.

Particularly comfortable operation of a motor vehicle provided with an electric motor and an associated traction battery can accordingly be enabled in which the driver, having parked the motor vehicle above the ground unit 10 and possibly initiated the charging process, does not need to undertake any further steps because the charging device 1 carries this out automatically and independently.

It is in particular not necessary for the user of the motor vehicle to have to manually lead a charging cable with a plug from a wallbox to the motor vehicle in order to establish contact and then has to plug it in appropriately and instead this manual process can be omitted.

Equally, it is possible to prevent by means of the proposed charging device 1 that a user tries to drive off whilst the motor vehicle is still contacted and then has to get out again in order to disconnect the cable. Rather, automatic independent decoupling can also be obtained by means of the proposed charging device 1 which is, for example, performed when the actual charging process has finished, i.e. the traction battery is completely full again, or is initiated, for example, by the motor vehicle being opened or someone entering the interior of the motor vehicle or switching on the motor vehicle. In other words, a user also does not have to undertake any active steps in order to decouple the existing contacting of the charging device 1. It can, however, also be provided that the user specifies active decoupling by a corresponding decoupling command.

The ground unit 10 of the charging device 1 has a housing 12 which is shown, for example, in FIGS. 1, 3, and 8 in a completely closed position. In the completely closed position, all the components of the charging device 1 which are situated inside the housing 12 are protected from the surroundings.

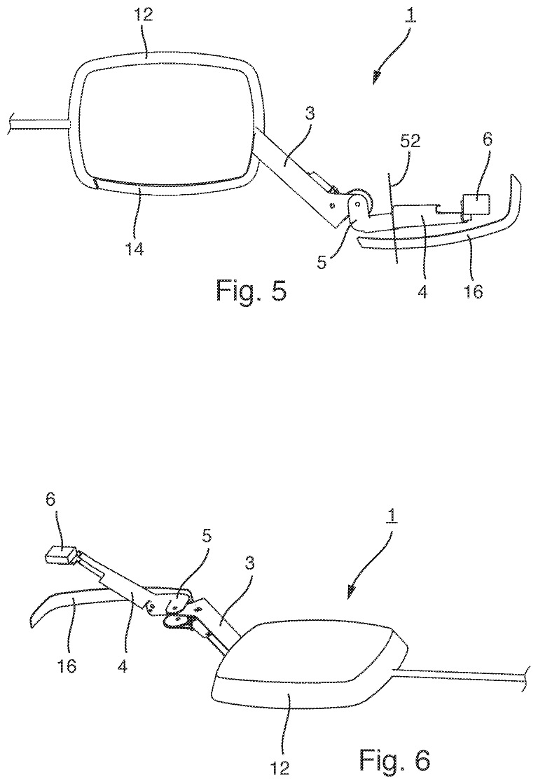

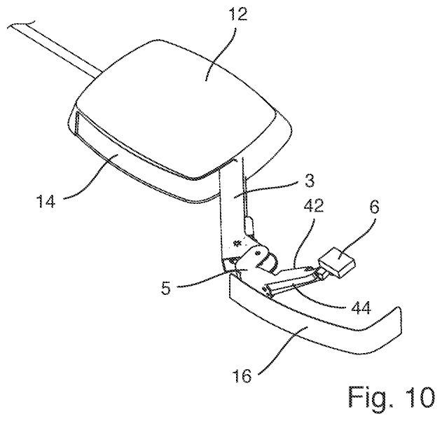

A lid or the upper side of the housing 12 has not been illustrated in FIGS. 1 to 4 purely for the sake of better visibility. However, during regular operation of the charging device 1, the upper side is always closed, as is also clear from, for example, FIGS. 5 to 10.

It is therefore important, inter alia, to provide the housing 12 of the charging device 1 because the ground unit 10 mounted on the ground of the respective parking space must be protected from dirt and moisture. Dirt and moisture could penetrate into parts of the charging device 1 from the motor vehicle parked above it. For example, dirt can fall from the vehicle parked above and in particular its underbody or dirty or melted water can drip down from the underbody of the motor vehicle parked above the charging device 1 and in particular the ground unit 10.

Furthermore, for example when the charging device 1 is arranged in a garage or another regular parking space which is not permanently occupied by a motor vehicle, because of the housing 12 the risk can be reduced that people walking past or stepping over are injured on the components of the charging device 1 or accidentally damage the charging device 1. Accordingly, the housing 12 preferably has such a stable design that an adult can stand on the lid without causing any damage. The housing 12 particularly preferably has such a stable design that there is no reason to fear damage to the ground unit 10 even when it is driven over directly by a motor vehicle.

In the housing 12 is provided a contacting arm 2 which is attached inside the housing 12 at one end on a vertical pivot axis 30 and at the free end 20 of which a contacting device 6 is provided which serves ultimately to form a contact with a complementary contacting means in the motor vehicle (not shown here).

The contacting device 6 can be designed in any suitable form, for example as a plug, which can be correspondingly introduced into the complementary contacting means in the underbody of the motor vehicle. Contacting of the contacting device 6 with the contacting means of the motor vehicle preferably takes place along a horizontal plane, i.e. according to the standard system of coordinates in the X-Y plane in the installed situation of the charging device 1 and the contacting means. In other words, the actual contacting preferably takes place not by virtue of a vertical movement (in the Z direction) but instead by movement within a plane parallel to the ground (X-Y plane).

The ground unit 10 of the charging device 1 is here, as already mentioned, preferably arranged on the ground of a parking space or a garage. The ground unit 10 is accordingly situated already in an orientation which corresponds to a horizontal plane, i.e. an X-Y plane. The contacting arm 2 can here pivot in the X-Y plane about a pivot axis 30 arranged inside the housing 12 and arranged to perpendicular to the horizontal plane.

Specifically, a main link 3 is arranged pivotably on the vertically oriented pivot axis 30, wherein the main link 3 can accordingly exclusively carry out a pivoting movement about the pivot axis 30 owing to the attachment to the vertical pivot axis 30. When it pivots, the main link 3 thus always moves in the X-Y plane, i.e. parallel to the ground.

A secondary link 5 is likewise pivotably attached to the free end 32 of the main link 3 via a vertical pivot axis 50. The secondary link 5 can thus also only carry out a pivoting movement about a vertically oriented pivot axis 50 such that pivoting of the secondary link 5 likewise proceeds exclusively in the X-Y plane, i.e. parallel to the ground.

Accordingly, both the main link 3 and the secondary link 5 can in each case only carry out a pivoting movement about a vertically arranged pivot axis 30, 50. Any movement of the main link 3 and the secondary link 5 is thus possible only in a horizontal plane.

The horizontal plane hereby corresponds to a plane which is oriented parallel to the ground of the parking space on which the ground unit 10 is mounted.

A lifting link 4 is attached to the secondary link 5. The main link 4 can pivot about at least a pivot axis 52 which extends horizontally. Because the pivot axis 52 is arranged horizontally and accordingly lies perpendicular to the two vertical pivot axes 30, 50, the lifting link 4 can be raised and lowered at its free end 40 in pivoting fashion about the pivot axis 52.

Raising or lowering of the contacting device 6 can thus accordingly also be obtained by means of the lifting link 4 in order ultimately to raise it starting from a height at which the lifting link 4 was stowed, together with the main link 3 and the secondary link 4, in the housing 12 in the rest position to a height above the ground which corresponds to a contacting height for connecting the contacting device 6 to a contacting element in the underbody of the motor vehicle.

After the contacting device 6 has then been raised to the corresponding contacting height by means of the lifting link 4, owing to further displacement of the contacting device 6 by means of the main link 3 and the secondary link 5, movement then takes place in the X-Y plane in order in this way to enable complete contacting between the contacting device 6 and a contacting means of the motor vehicle.

Furthermore, at least one drive 34 for pivoting the main link 3 is arranged in the housing 12, wherein the drive 34 can be, for example, an electric motor, a servomotor, or a linear motor by means of which a reliable, rapid, reproducible, and at the same time energy-saving pivoting of the main link 3 about the vertically arranged pivot axis 30 can be obtained.

A further drive 54 is arranged at the free end 32 of the main link 3, by means of which a pivoting of the secondary link 5 about the vertically arranged pivot axis 50 can be obtained.

A further drive 44 is provided at the free end 40 of the lifting link 4, by means of which a pivoting of the free end 40 of the lifting link 4 about the horizontally arranged pivot axis 52 can take place.

The charging device 1 furthermore comprises, in the interior of the housing 12, an electronic system 62 via which, on the one hand, the contacting arm is controlled and which can communicate with a communications module of the motor vehicle which is to be charged.

The communication between the electronic system 62 and the motor vehicle can comprise, for example, the exchange of information on the charging state of the traction battery of the motor vehicle, the right to charge at the charging device 1, authentication or authorization of the charging process, the transfer of charging parameters, control of the actual charging process, or alternatively manual initiation of a charging process by a user of the motor vehicle. Furthermore, information can be exchanged via the communication between the electronic system 62 and the motor vehicle that the charging process needs to be terminated because, for example, a user enters the motor vehicle and prepares to drive off in the motor vehicle.

The electronic system 62 can furthermore comprise modules for preparing, monitoring, and topping up the charging current for charging the motor vehicle, wherein the charging current is conducted to the contacting device 6 from the electronic system 62 via an appropriate power cable 60.

As can be seen, for example, from FIG. 2, the housing has an opening 14 through which the contacting arm 3 can pass out of the housing 12 with its free end 20.

As is clear from a comparison of FIGS. 1 and 2, the opening 14 is closed in the rest position by a closure element 16. The closure element 16 can accordingly be designed as part of the side wall of the housing 12 which fits exactly in the opening 14. In other words, the closure element 16 closes the housing 12 and in particular the opening 14 of the housing 12 such that, in the closed state, the housing 12 has a uniform closed appearance.

The closure element 16 is retained on the secondary link 5 such that, when the contacting arm 2 moves out of the housing 12, the closure element 16 automatically comes with it and the opening 14 in the housing 12 is accordingly opened. The same of course also applies when closing, wherein the closure element 16 is here automatically brought along by the secondary link 5 such that the opening 14 is closed in the rest position.

In the exemplary embodiments shown, the opening 14 here extends in the housing 12 such that the possible range of movement of the contacting arm 2 is not restricted. In particular, the opening 14 here extends around a corner of the housing almost as far as the articulation point, predetermined by the pivot axis 30, of the main link 3.

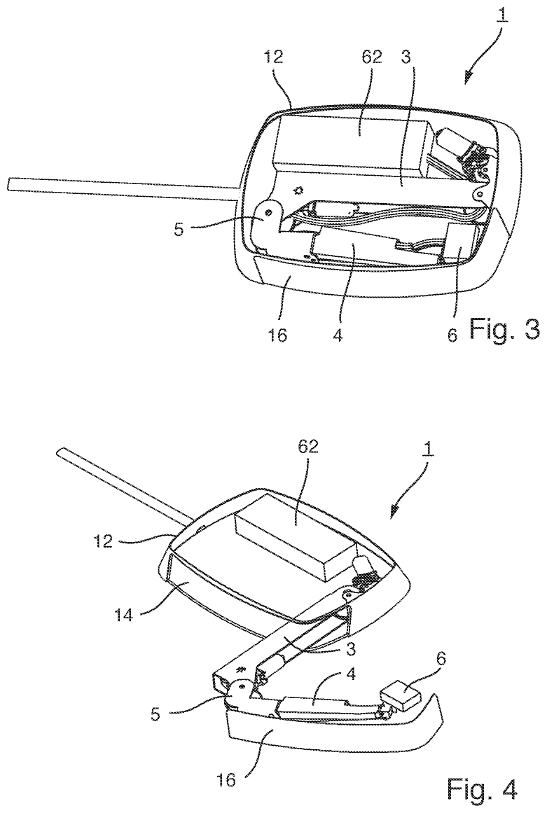

As is readily clear from FIGS. 1 and 3, the proposed charging device 1 has a particularly compact design because it can be arranged in a particularly compact housing 12. Because the main link 3, the secondary link 5, and the lifting link 4 can be accommodated in the housing 12 so that they are folded almost side by side, the housing 12 can have a particularly compact design.

In the view shown in FIG. 4 of the extended contacting arm 2, it can be seen that the lifting link 4 is raised out of the horizontal plane within which the main link 3 and the secondary link 5 lie and can be accordingly raised in the Z direction.

A flat design of the ground unit 10 of the charging device 1 can consequently be obtained because a raising movement is carried out only in an activated state of the contacting arm 2, but in the rest position the main link 3, the secondary link 5, and the lifting link 4 are arranged side by side in the X-Y plane. The structural height of the contacting arm 2 is thus predetermined at least in the rest position by the height of the highest profile of the main link 3, the secondary link 5, or the lifting link 4.

The individual components of the contacting arm 2 are not stacked on top of one another in the rest position, as is often the case with the prior art. Rather, all the components of the contacting arm 2 are situated side by side in the X-Y plane such that a particularly flat structural shape can be obtained.

The lifting link 4 is here preferably configured such that the contacting element 6, which can be designed, for example, in the form of a plug, maintains a predetermined orientation irrespective of the lifting position.

For this purpose, the lifting link 4 can be designed, for example, in the form of a parallelogram guide system. Two constituent links, arranged in a parallelogram, of the lifting link 4 are then preferably arranged on the secondary link 5 around two pivot axes arranged horizontally parallel to each other. The free end 40 of the lifting link 4 also has a parallelogram-like attachment to the contacting device 6. When the free end 40 of the lifting link 4 is raised and lowered, it is thus possible to ensure that the contacting device 6 is always situated in a predetermined orientation.

The parallelogram guide system with an upper constituent link 42 of the lifting link 4 and a lower constituent link 44 of the lifting link 4 can be seen particularly well in FIG. 5. In this way, a parallelogram guide system of the contacting device 6 can be obtained in combination with the secondary link 5 and the contacting device 6.

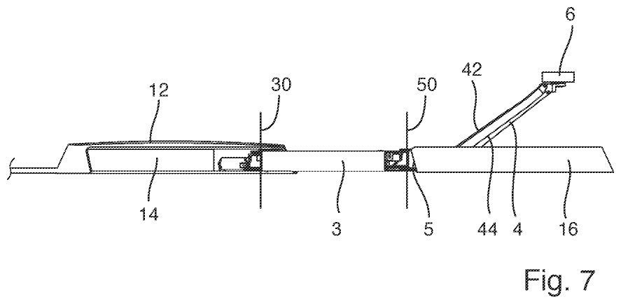

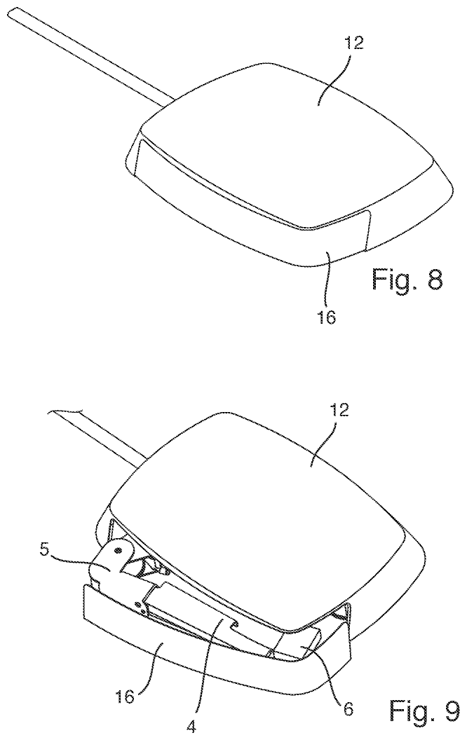

It can once more be seen particularly well in FIGS. 6 and 7 that the lifting link 4 raises the contacting element 6 from the plane within which the main link 3 and the secondary link 5 lie.

An advantage of the design shown here is, inter alia, that the movable components of the contacting arm 2, namely the main link 3, the secondary link 5, and the lifting link 4, can each pivot only about rotary bearings such that the structure of the charging device 1 is relatively simple, wherein the respective pivot bearings are not only more favorable in terms of delivery but also are more resistant to dirt and have a lower risk of jamming.

The electronic system 62 can, for example, communicate with the motor vehicle in order, for example, to automatically recontact the vehicle when, for example, the charging level of the traction battery falls below a predetermined level.

If the motor vehicle is accordingly parked above the ground unit 10 and if the communication with the electronic system 62 has identified that contacting of the motor vehicle or the traction battery of the motor vehicle needs to be performed, the electronic control system 62 controls the contacting arm 2 such that it is first folded out by pivoting about the axis 30 and about the axis 50 in the horizontal plane so far that it is possible for the lifting link 4 to be raised without colliding with the housing 12.

The electronic system 62 then displaces the contacting device 6 by means of the contacting arm 2 to the contacting height and then into the complementary contacting unit in the underbody of the motor vehicle in order to establish contact. The charging process can then be initiated via the electronic system 62 such that charging of the battery of the motor vehicle is obtained.

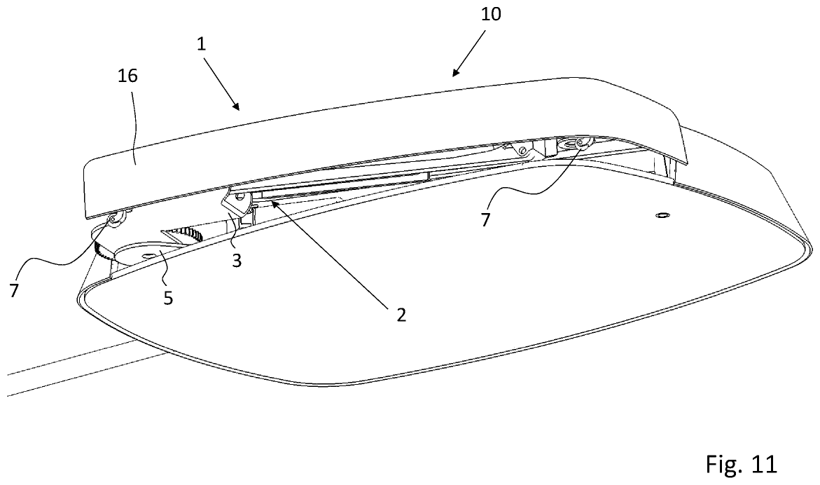

FIG. 11 shows a schematic perspective view of the ground unit 10 of the charging device 1 from below, i.e. looking at the ground unit 110 from the ground, with two support elements 7. In the embodiment shown here, the support elements 7 are arranged on the contacting arm 2. The contacting arm 2 can consequently be supported movably on the ground.

As shown by way of example, the support element 7 is configured as a roller, in particular as a pivotable roller. This enables low-noise operation of the contacting arm 2 because the contacting arm 2 is assisted in its pivoting movement in such a way that the contacting arm 2 does not touch the ground. It can consequently be prevented that the contacting arm grinds against the ground when the contacting arm 2 is pivoted out.

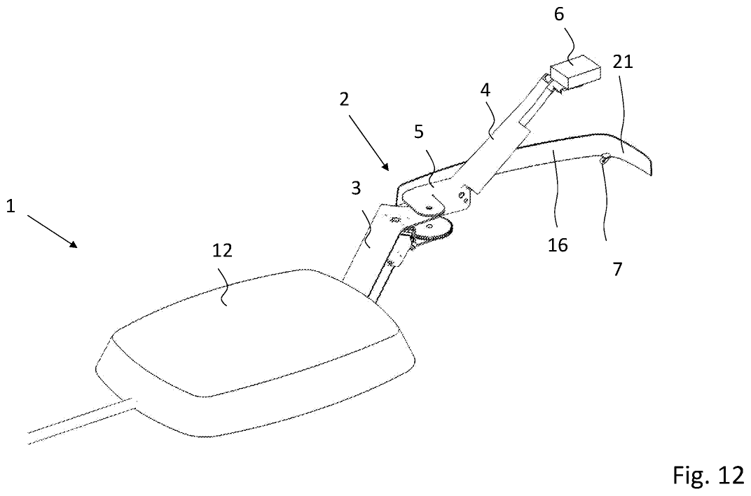

FIG. 12 shows a schematic perspective view of the charging device 1 with at least one support element 7 with the arm 2 extended in an active position. As shown here, the at least one support element 7 is arranged at a free end of the contacting arm 2 or at a free end of the closure part 21.

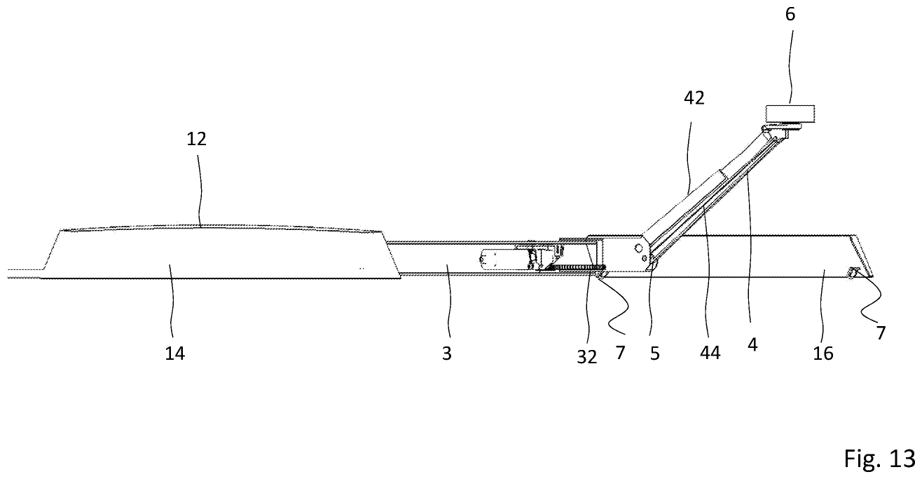

FIG. 13 shows a schematic side view of the charging device 1 with two support elements 7. As shown here, the support elements 7 are arranged on the closure part 16 in such a way that a first support element 7 is arranged at the height of the free end 32 of the main link 3 and a second support element 7 is arranged at the free end 21 of the closure part 16. Improved movement of the contacting arm 2 can be obtained as a result. In particular, grinding of the contacting arm 2 when it is extended and retracted is prevented as a result. Furthermore, the contacting arm 2 can be designed to be less stiff as it is supported by the support element 7 when it moves on the ground.

Where applicable, all the individual features which are illustrated in the exemplary embodiments can be combined and/or swapped with one another without going beyond the scope of the invention.

### LIST OF REFERENCE NUMERALS

1 charging device
10 ground unit
12 housing
14 opening
16 closure part
2 contacting arm
20 free end of the contacting arm
21 free end of the closure part
3 main link
30 pivot axis of the main link
32 free end of the main link
34 drive of the main link
4 lifting link
40 free end of the lifting link
42 upper constituent link
44 lower constituent link
46 drive of the lifting link
5 secondary link
50 pivot axis of the secondary link
52 horizontal pivot axis for attachment of the lifting link
54 drive for the secondary link
6 contacting device
60 power line
62 electronic system
7 support element

1. A charging device for charging a battery of a motor vehicle, comprising a ground unit for arrangement on the ground of a motor vehicle parking space, wherein the ground unit has a contacting arm, at a free end of which is arranged a contacting device for contacting a contacting unit in the motor vehicle, the contacting unit being complementary to the contacting device,
wherein the contacting arm has a main link which can pivot about a vertical pivot axis.

2. The charging device as claimed in claim 1, wherein the main link is attached to the ground unit so as to be pivotable about the vertical pivot axis.

3. The charging device as claimed in claim 2, wherein the contacting arm has a lifting link pivotable about a horizontal axis.

4. The charging device as claimed in claim 3, wherein the contacting arm has a secondary link pivotable about a vertical pivot axis, wherein the secondary link is at least one of: attached at a free end of the main link via the vertical pivot axis and attached to a lifting link via a horizontal pivot axis.

5. The charging device as claimed in claim 4, wherein a drive is provided which is configured to at least one of: pivot the main link about its vertical pivot axis, pivot the secondary link about its vertical pivot axis, and and/or that a drive (46) is provided which is configured to pivot the lifting link about its horizontal pivot axis.

6. The charging device as claimed in claim 5, wherein in a rest position, the contacting arm is accommodated completely in a housing, wherein the components of the contacting arm are arranged in the rest position in a plane parallel to the ground of the motor vehicle parking space.

7. The charging device as claimed in claim 5, wherein, in the rest position, the main link is accommodated in the housing parallel to the lifting link.

8. The charging device as claimed in claim 6, wherein an opening, through which the contacting arm can be pivoted from the rest position into a contacting position about the vertical pivot axis of the main link is provided in the housing.

9. The charging device as claimed in claim 8, wherein an electronic system is provided which is configured to provide a charging current to the contacting device.

10. The charging device as claimed in claim 9, wherein an the electronic system is provided which is configured to form a communication with a motor vehicle to be charged.

11. The charging device as claimed in claim 10, wherein a support element is arranged on at least one of: the contacting arm and the ground unit.

12. The charging device as claimed in claim 11, wherein the support element has at least one roller.

13. The charging device as claimed in claim 12, wherein the support element is arranged on at least one of: the main link, the secondary link, and the lifting link.

14. The charging device as claimed in claim 13, wherein the support element is arranged at the free end of at least one of: the main link and the contacting arm.

15. The charging device as claimed in claim 3, wherein the lifting link is attached to the contacting device at its free end.

16. The charging device as claimed in claim 6, wherein the components of the contacting arm comprise the main link, the secondary link, and the lifting link.

17. The charging device as claimed in claim 8, wherein the opening can be closed by a closure element in the rest position, and wherein the closure element is rigidly guided on the secondary link.

18. The charging device as claimed in claim 9, wherein the electronic system is configured to provide the charging current to the contacting device via a power cable which is laid in the contacting arm.

19. The charging device as claimed in claim 9, wherein the electronic system is provided which is configured to automatically control the contacting arm.

20. The charging device as claimed in claim 12, wherein the at least one roller is a pivotable roller.
